(19) United States
(12) Patent Application Publication
(10) Pub. No.: US 2011/0016445 A1
(43) Pub. Date: Jan. 20, 2011

(54) Layout design system and layout design method

(75) Inventor: Makoto Ueda, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/801,864

(22) Filed: Jun. 29, 2010

(30) Foreign Application Priority Data
Jul. 16, 2009 (JP) 2009-167808

(51) Int. Cl. G06F 17/50

(52) U.S. Cl. 716/111

(57) ABSTRACT

In a layout design of a semiconductor circuit, by selecting a frequently-used layout cell based on a layout design, a common location (coordinate) at which dummy metal is arranged is specified. A new layout cell in which dummy metal is arranged in advance at the specified arrangement location is generated. Dummy metal is arranged by replacing the frequently-used layout cell from which the new layout cell is generated by the new layout cell having dummy metal or by overlapping them. Thus, process such as wiring correction in which the amount of data depends on processing speed can be carried out by use of the inexpensive computer having low throughputs and the small amount of memory.

### INCORPORATION BY REFERENCE

This application is based upon and claims the benefit of priority from Japanese patent application No. 2009-167808, filed on Jul. 16, 2009, the disclosure of which is incorporated herein in its entirety by reference.

### BACKGROUND OF THE INVENTION

1. Field of the Invention

The present invention relates to a layout design system, in particular, a layout design system related to arrangement of dummy metal in design for manufacturability (DFM) of a semiconductor integrated circuit.

2. Description of Related Art

Since multi wiring layers are realized due to the advancement of microfabrication technique, a planarization is carried out in semiconductor manufacturing by using a polishing technique (CMP: Chemical Mechanical Polishing). When there is unevenness in distribution of metal wirings, mottles are generated in CMP and planarization cannot be achieved. Therefore, in a layout design method to satisfy a design for manufacturability of a semiconductor integrated circuit, dummy metals are required to be filled such that distribution density of metal wirings is a predetermined value or more in any position.

In recent years, in the design of semiconductor integrated circuit, since a circuit scale increases with the advancement of microfabrication, amount of dummy metal to be provided increases. For example, in a layout design in which a layout tool is used, the layout tool inputs layout data such as net list of circuits and coordinates at which the circuits are arranged (arrangement coordinates), processes the layout data, and outputs the processed layout data. Since arrangement coordinates of dummy metals are described in the layout data, as the number of dummy metals increases, the size of the layout data increases.

In FIG. 1, a flow of arranging dummy metals according to a general technique is shown and a general procedure of designing using a general tool is shown as a flow chart. FIG. 2 shows wiring layout data according to a conventional technique.

A wiring layout design method according to the general technique will be described below referring to FIGS. 1 and 2. At Step S11, I/O and macros are arranged. At Step S12, a power source wiring is carried out for the data after floor plan, for which the arrangement is carried out at Step S11. At Step S13, arrangement of layout cell is carried out for the data after the power source wiring of Step S12. At Step S14, signal wiring is carried out for the data after the layout cell arrangement of Step 313. At Step S15, arrangement of dummy metal is carried out for the data after the wiring of Step S14. At Step S16, a usage rate of the metal arranged at Step S15 is judged, and when the usage rate of the metal does not reach a target, Step S15 is repeated only for areas in which the dummy metal is not arranged. When the usage rate of the metal reaches the target, the flow is terminated.

In the arrangement of dummy metal at Step S15, distribution density of metal wiring is checked, dummy metal is arranged in an area in which the distribution density of metal wiring is less than a prescribed value such that the pitch between the arranging dummy metal and an existing wiring coincides with a predetermined minimum wiring pitch, and thereby the prescribed value is satisfied. As shown in FIG. 2, wiring layout data is generated in which actual wiring layout data 4a to 4j and dummy wiring layout data 7a are laid out on a layout cell arrangement region 5. The actual wiring layout data 4a to 4j are separated from the dummy wiring layout data 7a by a minimum wiring pitch determined in a layout design rule, and the dummy wiring layout data 7a is arranged with the minimum wiring pitch as same as the actual wiring layout data. The above-described dummy wiring layout data 7a is arranged by describing arrangement coordinate in a layer for each dummy wiring layout data 7a.

Referring to FIG. 3, an example of a method of arranging layout cells and dummy metals in the case of performing a layout according to the above-mentioned layout design method is described. FIG. 3 shows an example of a general method of arranging layout cells and dummy metals. A layout cell definition H901 defines the layout cells, indicates an end of definition of one layout cell by a semicolon, and defines information of the layout cells. A dummy metal description H902 includes descriptions of arrangement coordinates of the dummy metals. Rectangular coordinates of the dummy metal are described by two points of minimum coordinates of X and Y axes and maximum coordinates of X and Y axes, and a semicolon indicate an end of description of arrangement coordinate of single dummy metal. A layout cell arrangement coordinate description H903 includes descriptions of arrangement coordinates of the layout cells. The layout cell arrangement coordinate description H903 describes coordinates at which the layout cells defined in the layout cell definition H901 are arranged, and indicates an end of description of arrangement coordinate of one layout cell by a semicolon.

As related art, Japanese patent publication (JP-A-Heisei 5-258017) discloses a semiconductor integrated circuit device and a wiring layout method for the semiconductor integrated circuit device. According to the related art, actual wiring is formed to connect between elements formed in the semiconductor integrated circuit, and a grid-like dummy wiring with a minimum wiring pitch is formed in the same wiring layer of the actual wiring in the whole region of the semiconductor integrated circuit device such that the grid-like dummy wiring is separated from the actual wiring by the minimum wiring pitch and is not connected to any of actual wiring, element and terminal.

The present inventor has recognized as follows.

As described above, in recent LSI (Large Scale Integration) manufacturing, with the advancement of miniaturization of LSI, an integration density has increased and a gate scale has increased. This causes increase in data size required to fill dummy metal. The increase in the data size leads to a problem that an expensive computer having high throughputs and a large amount of memory needs to be used as a processing machine for wiring correction and the like.

The reason is considered as follows. According to the general technique, in order to fill dummy metal, in the arrangement of the dummy metal, the actual wiring layout data is generated based on circuit data of a semiconductor integrated circuit device and the grid-like dummy wiring layout data 7a with the minimum wiring pitch is generated over the whole region of the semiconductor integrated circuit device which is determined by the actual wiring layout data.

Consequently, it is impossible to specify a common location (coordinate) at which the dummy metal is arranged based on the different actual wiring layout data for each layout process and generate a new layout cell in which the dummy metal is arranged in advance at the specified arrangement location. Further, the layout data of the dummy metal is arranged by describing arrangement information for each dummy wiring layout data 7a. Furthermore, the amount of description of the layout data increases with an increase in the data size of the filled dummy metal. In addition, high throughputs and a large amount of memory are required to process the layout data.

### SUMMARY

In one embodiment, a layout design system includes: a first unit which selects a layout cell based on layout design and usage rate in a semiconductor integrated circuit, specifies a common coordinate at which dummy metal is arranged for the selected layout cell, and generates a new layout cell in which dummy metal is arranged in advance at the specified coordinate; and a second unit which uses the new layout cell in place of the selected layout cell.

In another embodiment, a layout design method of a semiconductor integrated circuit comprising: generating a new layout cell in which dummy metal is arranged in advance at a specified coordinate; and using the new layout cell in place of a selected layout cell. The generating the new layout cell includes: selecting a layout cell as the selected layout cell based on layout design and usage rate; and specifies a common coordinate as the specified coordinate at which dummy metal is arranged for the selected layout cell.

According to the layout design system and the layout design method, design can be carried out by using an inexpensive computer having low throughputs and a small amount of memory. Process such as wiring correction in which the amount of data depends on processing speed can be carried out by use of the inexpensive computer having low throughputs and the small amount of memory.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a flowchart according to a conventional technique;

FIG. 2 shows wiring layout data according to the conventional technique;

FIG. 3 shows an example of definition of layout cells, description of dummy metals and description of arrangement coordinates of the layout cells according to the conventional technique;

FIG. 4 is a block diagram illustrating a schematic configuration of a layout, design system of a semiconductor circuit device according to an embodiment of the present invention;

FIG. 5 shows a logical circuit according to the embodiment of the present invention;

FIG. 6 is a flow chart of generating a new layout cell having dummy metals according to a first embodiment of the present invention;

FIG. 7 shows the number of layout cells and area of layout cell in a circuit diagram according to the embodiment of the present invention;

FIG. 8 shows layout cell arrangement and a wiring state according to the embodiment of the present invention;

FIG. 9 shows only layout cell arrangement and a specific wiring layer (first layer) according to the embodiment of the present invention;

FIG. 10A shows wiring tracks of layout cell;

FIG. 10B shows coordinate names given to the wiring tracks of the layout cell;

FIG. 11A is a diagram in which a layout cell and first layer according to the embodiment of the present invention are extracted and shown;

FIG. 11B shows digitized wiring layer pattern according to the embodiment of the present invention;

FIG. 12 is a detailed flow chart of generating process of the new layout cell having dummy metal according to the embodiment of the present invention;

FIG. 13 is a data list in wiring data summarization process according to the embodiment of the present invention;

FIG. 14 is the data list in non-common pattern retrieval process according to the embodiment of the present invention;

FIG. 15 is the data list in non-common pattern elimination process according to the embodiment of the present invention;

FIG. 16 is the data list at the time when the number of arranged dummy metals has maximum value according to the embodiment of the present invention;

FIG. 17 is the data list at the time when the number of arranged dummy metals is saturated according to the embodiment of the present invention;

FIG. 18 is the data list showing an optimum common pattern according to the embodiment of the present invention;

FIG. 19 shows a new layout cell (cell name: CELL1) according to the embodiment of the present invention;

FIG. 20A shows data representing an optimum common pattern of a first wiring layer according to the embodiment of the present invention;

FIG. 20B shows the optimum common pattern of the first wiring layer as a layout cell according to the embodiment of the present invention;

FIG. 20C shows a layout cell having new dummy metals in the first wiring layer according to the embodiment of the present invention;

FIG. 21A shows data representing an optimum common pattern of a second wiring layer according to the embodiment of the present invention;

FIG. 21B shows the optimum common pattern of the second wiring layer as a layout cell according to the embodiment of the present invention;

FIG. 21C shows a layout cell having new dummy metals in the second wiring layer according to the embodiment of the present invention;

FIG. 22 shows a new layout cell (cell name: CELL1_METAL1) having dummy metals according to the embodiment of the present invention;

FIG. 23 shows dummy metals which are arranged by performing replacement by using the new layout cell according to the embodiment of the present invention;

FIG. 24 shows relationship among layout cells, arrangement coordinates of dummy metals and grids according to the embodiment of the present invention;

FIG. 25 shows an example of definition of the layout cells, description of the dummy metal and description of the arrangement coordinates of the layout cells according to the first embodiment of the present invention;

FIG. 26 is a flow chart of generating a new layout cell having dummy metals according to a second embodiment of the present invention;

FIG. 27 is a flow chart of generating a new layout cell having dummy metals according to a third embodiment of the present invention;

FIG. 28 is a detailed flow chart of generating process of the new layout cell having dummy metals according to the third embodiment of the present invention; and

FIG. 29 shows an example of definition of the layout cells, description of the dummy metal and description of the arrangement coordinates of the layout cells according to third embodiment of the present invention.

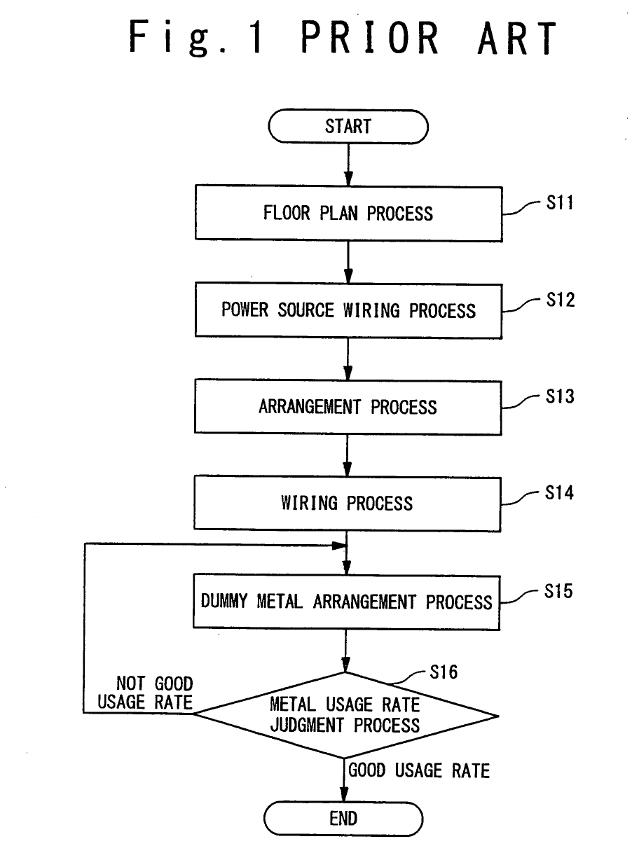

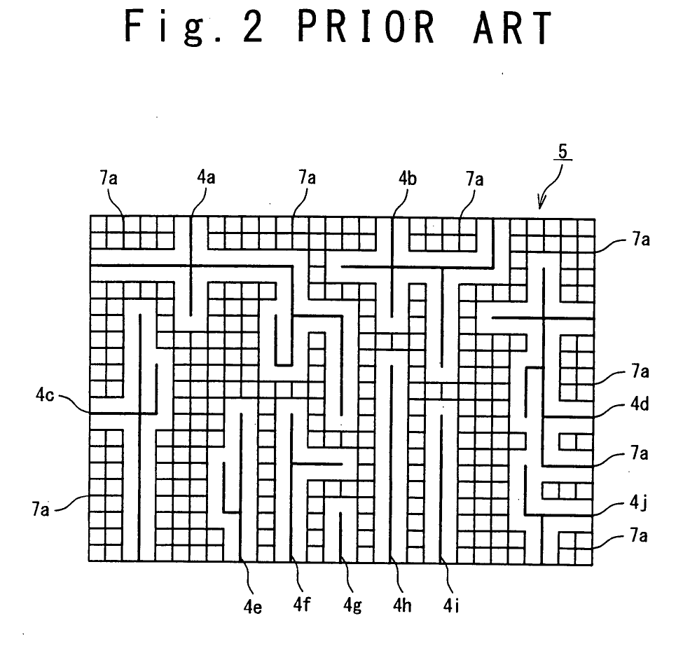

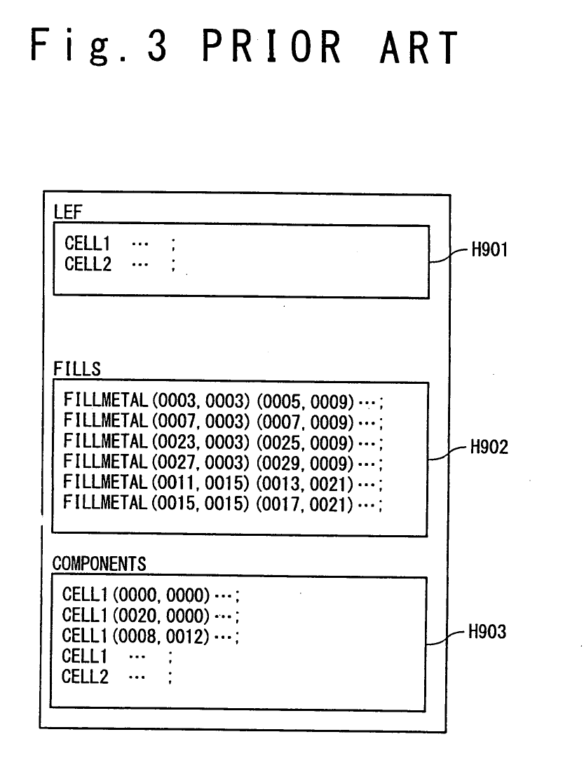

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

A first embodiment of the present invention will be described below referring to the attached drawings.

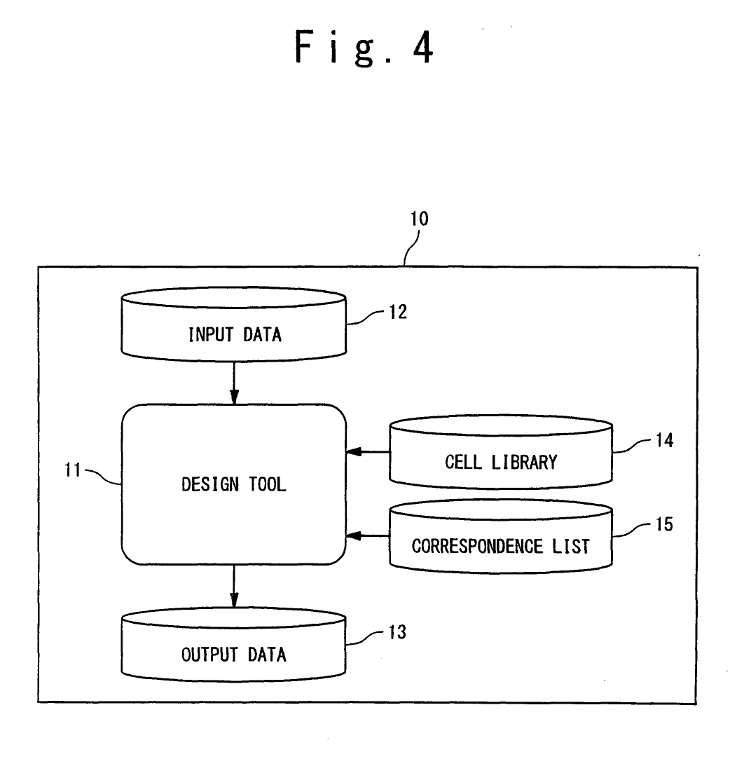

A layout design method according to the present embodiment can be carried out by a layout design system using a computer. FIG. 4 shows an example of a configuration of the layout design system using the computer.

As shown in FIG. 4, a layout design system 10 according to the present embodiment includes a design tool 11, input data 12, output data 13, a cell library 14 and a correspondence list 15.

The design tool 11 includes a design program. The input data 12 is inputted to the design tool 11. The output data 13 is outputted from the design tool. The cell library 14 is referred to by the design tool 11. The correspondence list 15 is referred to by the design tool 11. Here, the design tool 11 refers to the cell library 14 and the correspondence list 15 and generates the output data 13 from the input data 12.

An example of the computer that can serve as the layout design system 10 includes a PC (personal computer), thin client terminal/server, a work station, a mainframe computer and a supercomputer. The layout design system 10 is not limited to the computer itself but may be relay equipment, peripheral equipment, an expansion board mounted to a computer, virtual machine (VM) environment built on a computer or the like. However, in fact, the layout design system 10 is not limited to these examples.

An example of hardware that implements the design tool 11 includes: a processor such as a CPU (Central Processing Units), and a microprocessor; or a semiconductor integrated circuit (IC) having the same function as that of the processor. That is, the design tool 11 is implemented by hardware such as CPU which is driven based on a program and software based on which the hardware is driven to perform desired processes. However, in fact, the design tool is not limited to these examples.

An example of hardware for inputting the input data 12 includes: an interface (I/F) for acquiring information from an external input device or storage device; a driving device for reading and writing data from and to storage media; a network adaptor such as NIC (Network Interface Cards); an antenna; and a communication port. An example of the input device includes a keyboard, a keypad, a keypad on screen, a touch panel and a tablet. However, in fact, the hardware for inputting the input data 12 is not limited to these examples.

An example of hardware for outputting the output data 13 includes: an interface for outputting information to an external display device or storage device; a driving device for reading and writing data from and to the storage media; a network adaptor such as NIC; an antenna; and a communication port. An example of the display device includes an LCD (Liquid Crystal Display), a PDP (Plasma Display Panel), an organic EL display (organic electroluminescence display) and a printer for printing outputted contents on paper or the like. However, in fact, the hardware for outputting the output data 13 is not limited to these examples.

An example of storage means for folding the software for the design tool 11, the input data 12, the output data 13, the cell library 14 and the correspondence list 15 includes: a semiconductor storage device such as an EEPROM (Electrically Erasable and Programmable Read Only Memory) and a flash memory; an auxiliary storage device such as a hard disk and an SSD (Solid State Drive); and storage media such as a DVD (Digital Versatile Disk) and a memory card. The storage means is not limited to a storage device installed in a main unit of a computer but may be a peripheral device (external HDD or the like), a storage device installed in an external server (storage server or the like) or NAS (Network Attached Storage). However, in fact, the storage means is not limited to these examples.

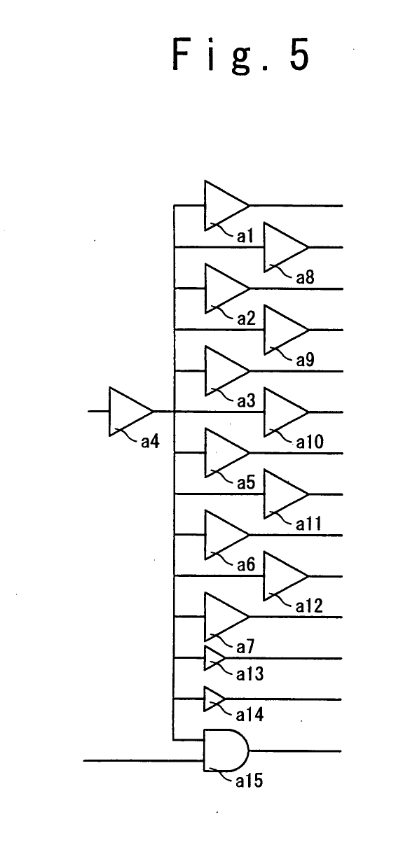

An operation according to the first embodiment of the present invention will be described, for example, in the case that a logical circuit shown in FIG. 5 is laid out on a semiconductor substrate and that dummy metals are arranged.

Instances a1 to a15 in the logical circuit in FIG. 5 can be classified based on cell types, into three groups including: a group of the instances a1 to a12, a group of the instances a13 and a14, and a group of the instance a15.

The instances a1 to a12 includes CELL1s which are buffers performing the same logical operation (function) and cells of cell type having large driving ability, and have individual names a1 to a12.

The instances a13 and a14 includes CELL2s which are buffers performing the same logical operation (function) as that of the CELL1 and cells of cell type having driving ability smaller than that of the CELL1.

The instance a15 includes CELL3 which is a buffer performing a logical operation (function) of AND different from those of CELL1 and CELL2 and a cell of cell type having the same driving ability as that of the CELL1. Inputs of the instances a1 to a3 and a5 to a15 are connected to an output of the instance a4.

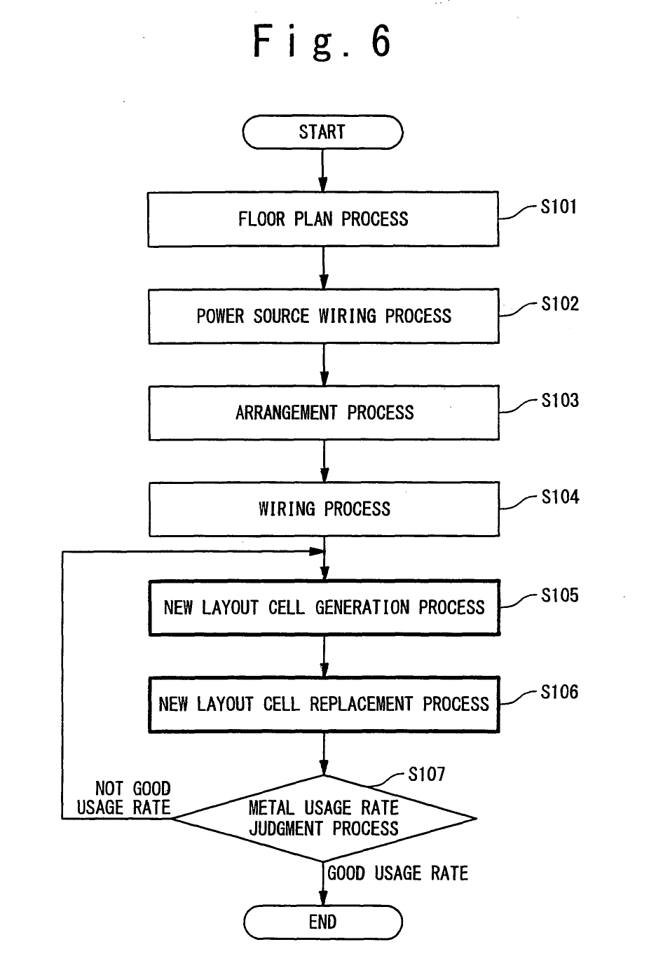

An outline of the first embodiment of the present invention will be described referring to a flowchart in FIG. 6.

### (1) Step S101

First, the design tool 11 performs floor plan arrangement of 10 terminals (input/output terminals) and macros.

### (2) Step S102

Next, the design tool 11 performs a power source wiring.

### (3) Step S103

Next, the design tool 11 arranges respective layout cells.

### (4) Step S104

Next, the design tool 11 performs a signal wiring.

### (5) Step S105

Next, the design tool 11 specifies locations at which dummy metals are arranged, newly generates a layout cell in which dummy metals are arranged in advance at the specified locations, and adds the layout cell to the cell library. Details of a method of generating the new layout cell will be described later.

### (6) Step S106

Next, the design tool 11 replaces the layout cell of the instance having the locations at which dummy metals are arranged by the generated new layout cell having dummy metals.

### (7) Step S107

Next, the design tool 11 judges whether or not metal usage rate after the replacement using the new layout cell satisfies a metal standard of the whole of one chip. When the metal usage rate after the replacement does not satisfy the metal standard of the whole of one chip, the design tool 11 is shifted to the new layout cell generation process (Step S105) again. When being shifted to the new layout cell generation process (Step S105) again, the design tool 11 first eliminates the instance in which the dummy metals are arranged at execution of the process at Step S106 from data of Step S106 and then, executes the processes of Step S105 and the following steps. When the metal usage rate after the replacement satisfies the metal standard of the whole of one chip, the design tool 11 terminates the flow.

Although not shown, the design tool 11 includes function units for executing the processes of Steps S101 to S107. Here, the design tool 11 includes a floor plan process unit (Step S101), a power source wiring process unit (Step S102), an arrangement process unit (Step S103), a wiring process unit (Step S104), a dummy metal-arranged layout cell generation process unit (Step S105), a dummy metal-arranged layout cell replacement process unit (Step S106) and a metal usage rate judgment process unit (Step S107). It should be noted that although these units are conceptually separated from each other, these units may be integrated physically in arbitrary combination.

Next, a procedure for generating the new layout cell at Step S105 will be described referring to FIGS. 5 to 22.

In the method of generating the new layout cell, in order to commonly and efficiently arrange dummy metals in cells of the same cell type in the target layout, wiring data on the instances are summarized, common locations (coordinates) are specified at which dummy metals are arranged, and a common pattern is obtained. By again summarizing the wiring data for the layout data from which instances recognized as the common pattern are eliminated, a common pattern is repeatedly obtained to generate a layout cell in which one or more dummy metals are arranged.

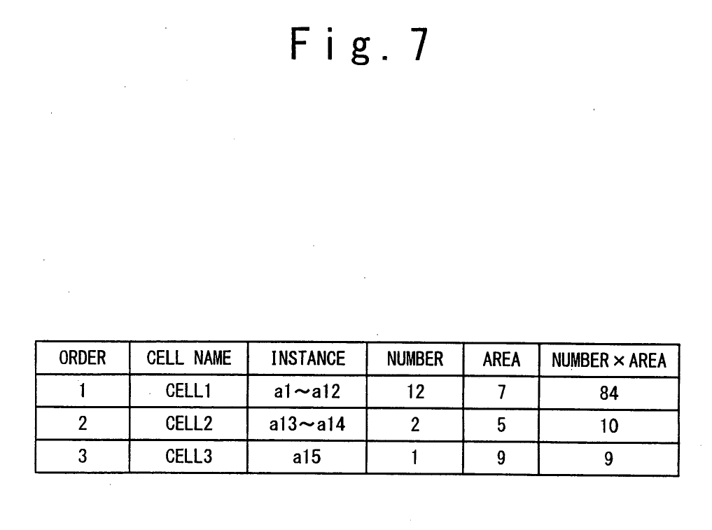

FIG. 7 shows with respect to the logical circuit in FIG. 5, cell names of cell types, instance names, number of cells for each cell type, layout area of a cell for each cell type, values (total areas) each obtained by multiplying the number of cells by the layout area of the cell and orders of the values obtained by multiplying.

With respect to the instances a1 to a12 in the logical circuit shown in FIG. 5, the cell name of cell type is CELL1, the number of cells is twelve, and the layout area is seven. Consequently, the total area of the layout cells of CELL1 is eighty four. Since the total area “84” of the layout cells of CELL1 is the largest comparing to the total areas of the other cells, the order is the first.

With respect to the instances a13 and a14 in the logical circuit shown in FIG. 5, the cell name of cell type is CELL2, the number of cells is two, and the layout area is five. Consequently, the total area of the layout cells of CELL2 is ten. Since the total area “10” of the layout cells of CELL2 is the second largest after the largest total area “84” of CELL1, the order is the second.

With respect to the instance a15 in the logical circuit shown in FIG. 5, the cell name of cell type is CELL3, the number of cells is one, and the layout area is nine. Consequently, the total area of the layout cells of CELL3 is nine. Since the total area “9” of the layout cells of CELL3 is the smallest comparing to the total areas of the other cells, the order is the third.

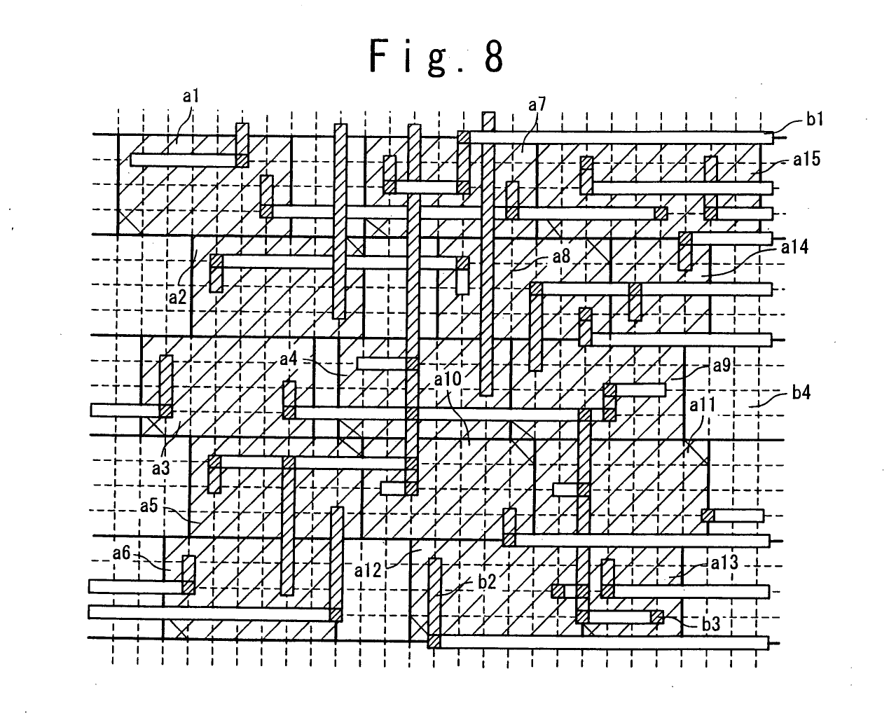

FIG. 8 shows an arrangement of layout cells and a wiring state when the layout of the logical circuit shown in FIG. 5 is performed. A symbol b1 denotes a first layer wiring. A symbol b2 denotes a second layer wiring. A symbol b3 denotes a first-second layer via. A symbol b4 denotes a wiring track.

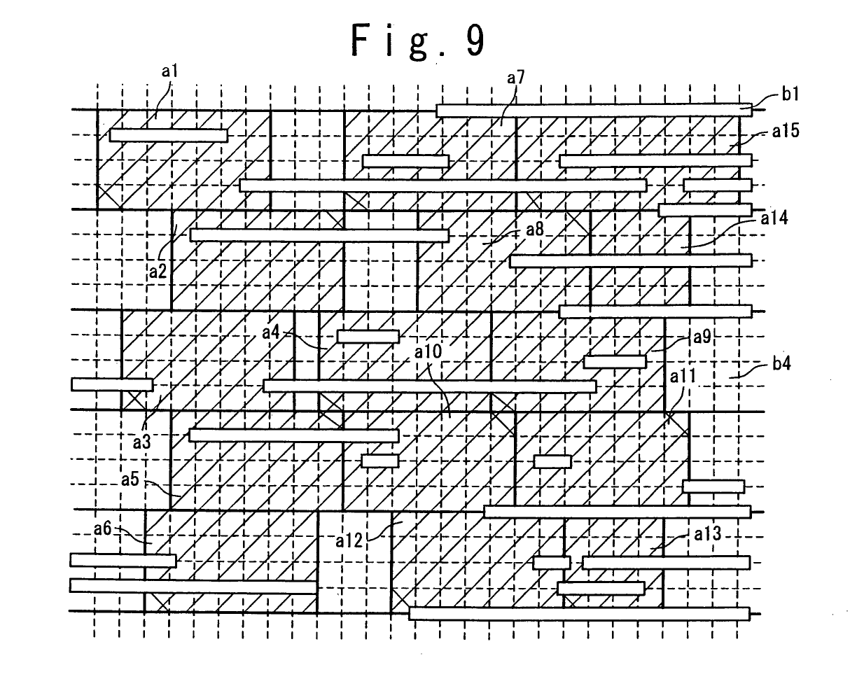

FIG. 9 shows only the layout cell arrangement and a specific wiring layer (first layer) in FIG. 8. A symbol b1 denotes a first layer wiring. A symbol b4 denotes wiring track.

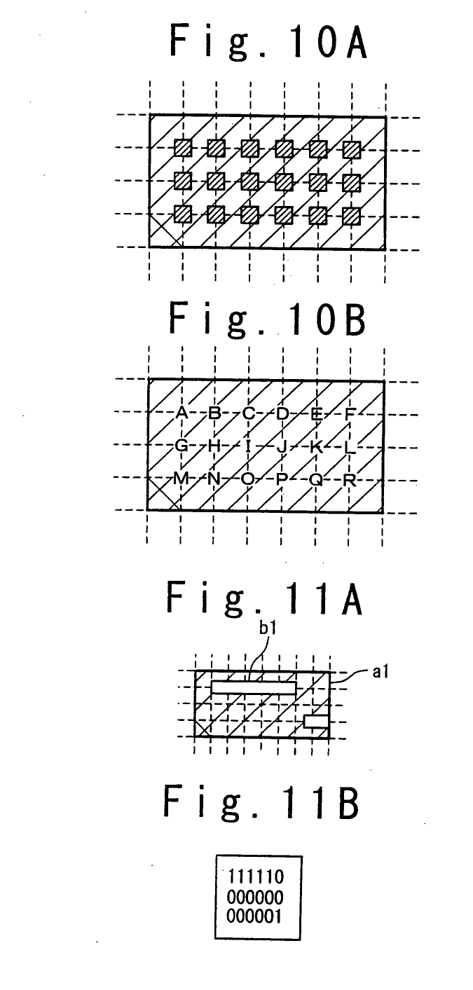

FIG. 10A shows wiring tracks in the layout cell of the instance a1. Hatched rectangles represent coordinates of intersections of wiring tracks of X and Y.

FIG. 10B shows coordinate names given to the wiring tracks in FIG. 10A. In FIG. 10B, in order to uniquely distinguish and recognize respective coordinates, for example, the coordinate names 1A to 1R and 2A to 2R are given by assigning symbols A to R and adding 1 to A to R in the case of the first layer and 2 to A to R in the case of the second layer.

In FIG. 11A, a portion of the instance al is extracted from the layout in FIG. 9 and only the first layer wirings b1 in the portion are shown. In FIG. 11B, with respect to the wiring layer patterns in FIG. 11A, an intersection of the wiring tracks having a wiring layer pattern is indicated by one and an intersection of the wiring tracks not having wiring layer pattern is indicated by zero. By using the coordinate names of the intersections of the wiring tracks shown in FIG. 10B, values for coordinate names 1A to 1R are digitized as “111110000000000001”.

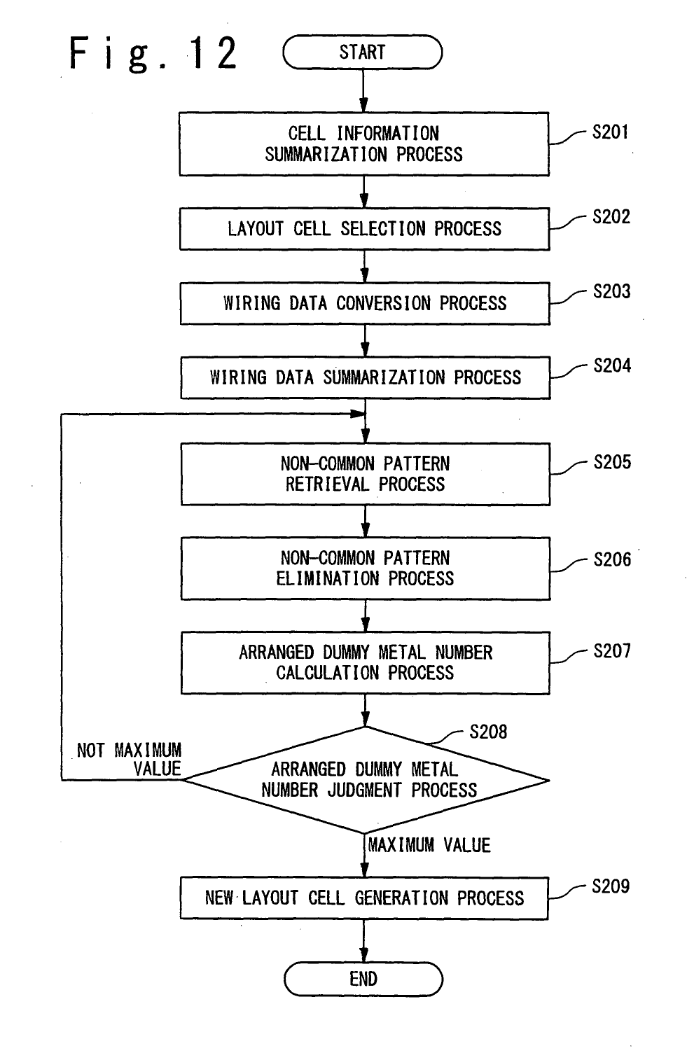

FIG. 12 is a flow chart showing the new layout cell generation process of Step S105 in detail.

### (1) Step S201

The design tool 11 classifies all instances in the layout data according to cell types, and for each cell type, calculates the number of cells and layout area of a cell to obtain the layout total area as the product of the number of cells and the layout area of the cell. At this time, the design tool 11 obtains the number of cells, the area, and the total area for each cell type used in the circuit diagram shown in FIG. 7 and the order of the cell types in decreasing manner, by putting the total area of the layout in decreasing order.

### (2) Step S202

The design tool 11 selects CELL1 as the cell type having the largest total area of layout cell, which is obtained at Step S201.

### (3) Step S203

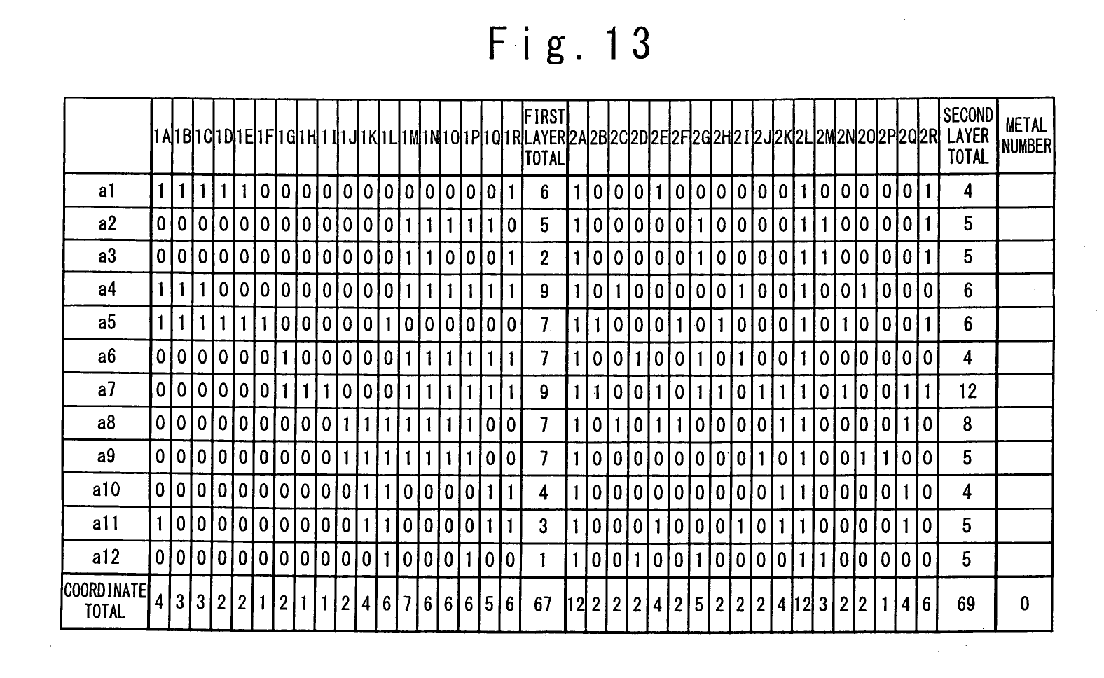

The design tool 11 generates a wiring database for the instances using CELL1 selected at Step S202. FIG. 13 is a data list in which wiring data is summarized. The respective instances using the selected cell are shown in a first column. In the present embodiment, the instances a1 to a12 are shown. The coordinate names of the wiring tracks are shown in a first row. In the present embodiment, the coordinate names 1A to 2R are shown.

### (4) Step S204

The design tool 11 summarizes values in the wiring database that are generated at Step S203. In FIG. 13, in the present embodiment, total twelve of instances a1 to a12 are shown in rows, respectively. For each instance, numbers of wirings are shown in a row. Total sums of the numbers of wirings of the instance, namely total sums of the numbers of wirings for the coordinate names A to R, are respectively calculated for the wiring layers and are shown as a first layer total and a second layer total which are totals for the first layer and the second layer.

For each of the coordinate names 1A to 2R of the wiring tracks, a sum total of numbers of wirings of the instances a1 to a12 for a coordinate name of the wiring tracks is calculated as a coordinate total. Namely, for each of the coordinate names 1A to 2R, a sum total in a column is calculated as the coordinate total.

In the present embodiment, the first layer total of the instance a1 is “6” as the total of “1A=1, 1B=1, 1C=1, 1D=1, 1E=1, 1F=0, 1G=0, 1H=0, 1I=0, 1J=0, 1K=0, 1L=0, 1M=0, 1N=0, 1O=0, 1P=0, 1Q=0, and 1R=1”.

In the present embodiment, the coordinate total of the coordinate name 1A is “4” as the total of “instance a1=1, instance a2=0, instance a3=0, instance a4=1, instance a5=1, instance a6=0, instance a7=0, instance a8=0, instance a9=0, instance a10=0, instance a11=1, and instance a12=0”.

According to the above-mentioned totals, numbers of wirings which exist at the coordinates on the plurality of instances are obtained. Furthermore, when a dummy metal is arranged on a coordinate, the dummy metal can be arranged in an instance in which there is no wiring at the coordinate since a wiring and the dummy metal do not overlap each other. When the value of the coordinate total is small, many dummy metals can be arranged on the coordinates in the whole layout.

The total number of coordinates at which dummy metals are arranged are calculated as a number of intersections (coordinates) of the wiring tracks, and a specific calculation method will be described in the description of Step S207.

### (5) Step S205

The design tool 11 selects an instance having a minimum number of the coordinate totals obtained at Step S204. When there are a plurality of coordinates having the minimum number, an instance having a maximum number of the wiring layer total is selected among the selected plurality of instances. In other words, an instance that uses the corresponding wiring layer most in the layout cell having the maximum number of coordinates without wiring is selected.

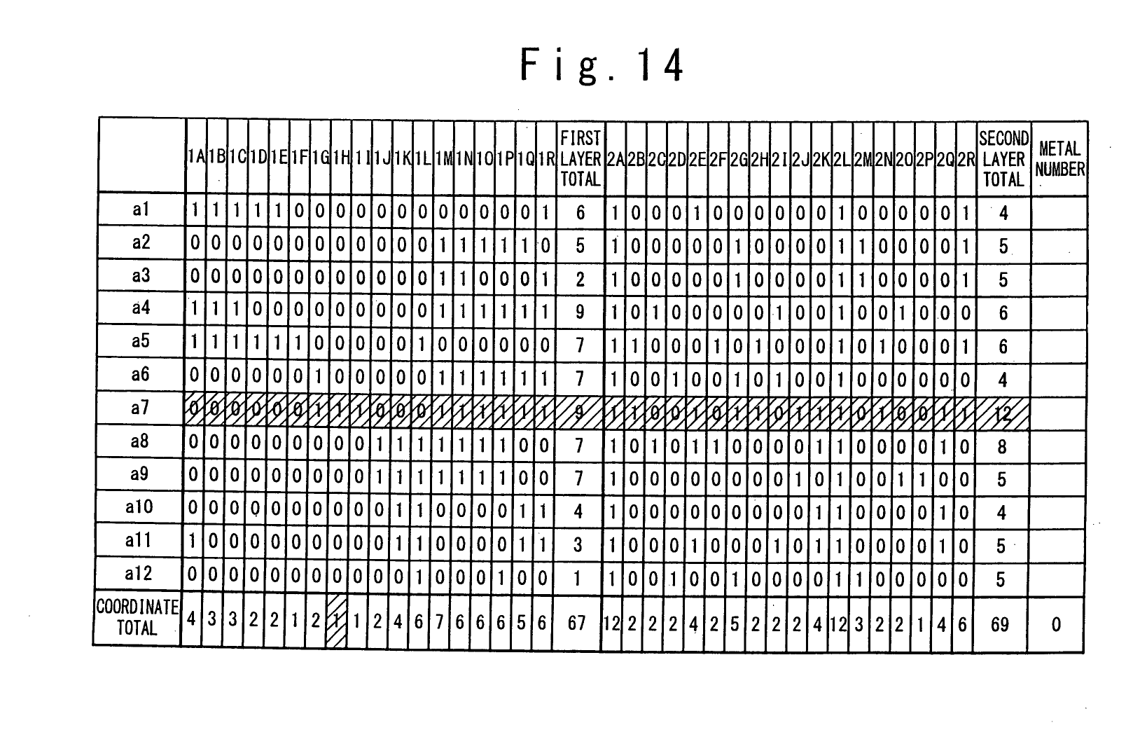

For example, in the case of FIG. 13, the instances having the minimum coordinate total are three instances of “a5”, “a7” and “a9” each of which uses at least one of four coordinates “1F”, “1H”, “1I” and “2P” with the coordinate total of 1 for wiring. The corresponding wiring layer totals of the three instances a5, a7, and a9 are “7”, “9”, and “5”, respectively. The instance having the maximum wiring layer total among the three instances is the instance a7 having the first layer total of “9”. FIG. 14 indicates by hatching, that the coordinate 1H on the tracks and the instance a7 satisfy the condition and are selected through the above-mentioned process,

### (6) Step S206.

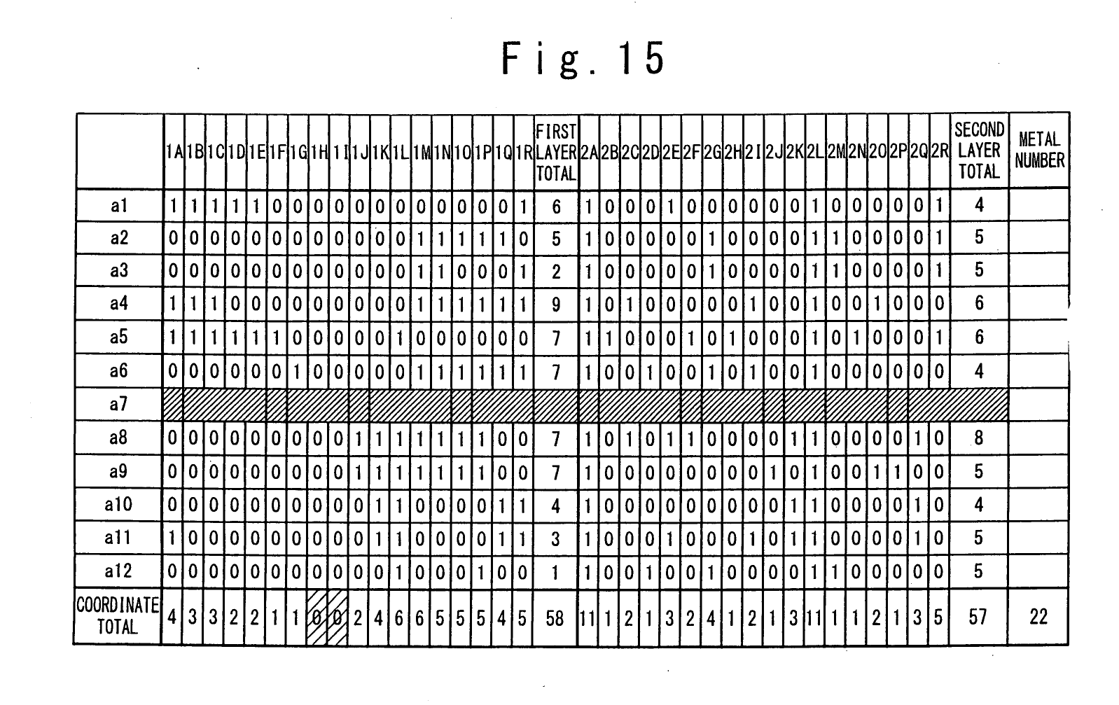

The design tool 11 regenerates the wiring database in which the instance a7 selected at Step S205 is eliminated. In the regenerated wiring database, the coordinate totals for the coordinates 1H and 1I which are used by the selected instance a7 for wiring are “0”. FIG. 15 shows that data of the instance a7 is eliminated and the coordinate totals for the coordinates 1H and 1I becomes “0” and shows the eliminated data and the coordinate totals of “0” by hatching.

### (7) Step S207

The design tool 11 calculates a number of intersections (coordinates) of the wiring tracks in the wiring database generated at Step S206. The number of intersections (coordinates) of the wiring tracks is a value obtained by calculating a number of coordinates having the coordinate total of “0” and multiplying the number of coordinates by a number of remaining instances other than the instance eliminated at Step S206. For example, in FIG. 15, the number of intersections (coordinates) of the wiring tracks is calculated as “22” by multiplying two as the number of coordinates having the coordinate total of “0” by eleven as the number of instances in the wiring database, and is shown as a metal number in the intersection of the lowermost row and the rightmost column.

### (8) Step S208

The design tool 11 repeats the processes of Steps S205 to S207 for n times (n is two or more integer) by using the wiring database generated again at Step S206 to obtain an optimum common pattern.

FIG. 15 shows a data list in which data of the instance a7 is eliminated when the processes are executed for n=2 times.

The processes of Steps S205 to S207 are repeated for n of more than two.

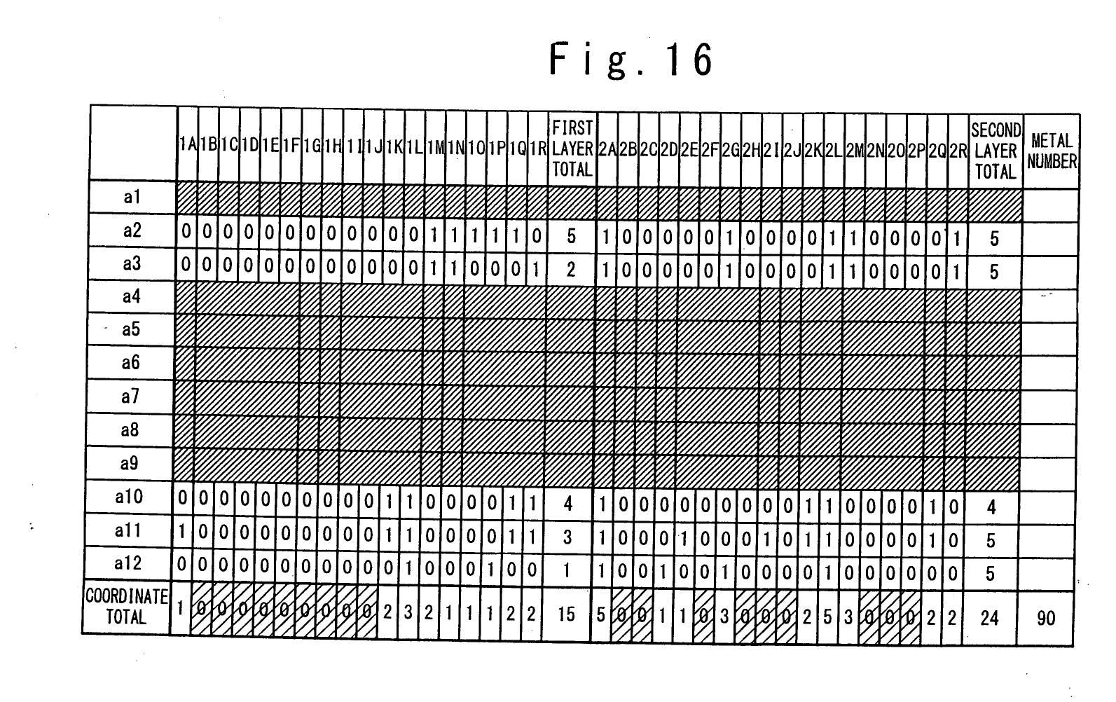

FIG. 16 shows a data list in which data of the instances a1 and a4 to a9 are eliminated when the processes are executed for n=7 times.

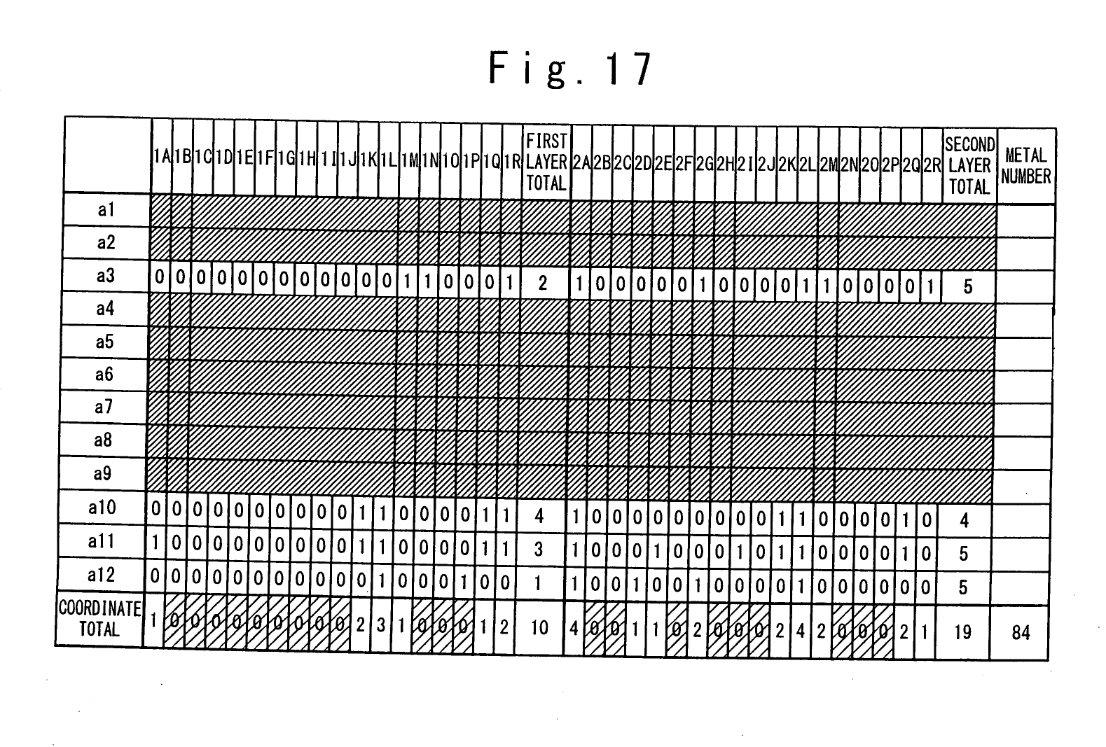

FIG. 17 shows a data list in which data of the instances a1, a2 and a4 to a9 are eliminated when the processes are executed for n=8 times.

In FIGS. 15 to 17, portions of the eliminated data and the coordinate total “0” are indicated by hatching,

When the metal number obtained at the n-th Step S207 is equal to or smaller than that obtained at the n−1-th Step S207, the wiring database of n−1-th time is judged to be the optimum common pattern and retrieval of the common pattern is finished.

In the present embodiment, as shown in FIG. 16, the metal number in the case that the processes are repeated for n=7 times is ninety obtained by multiplying eighteen as the number of the coordinates on the tracks having the total wiring number of “0” by five as the number of instances in the wiring database.

As shown in FIG. 17, the metal number in the case that the processes are repeated for n=8 times is eighty four obtained by multiplying twenty one as the number of the coordinates on the tracks having the total wiring number of “0” by four as the number of instances in the wiring database.

The metal number is eighty four in the case of n=8 and ninety in the case of n=7. Thus, since the metal number in the case of n=7 is larger than that in the case of n=8, the wiring database at n=7 is judged as the optimum common pattern. Since the metal number in the database of n-th time is the total number of the cell coordinates at which dummy metals can be arranged in layout, the wiring pattern having the maximum metal number when the metal number increases from n−1-th time to n-th time and decreases from n-th time to n+1-th time is obtained as the optimum common pattern.

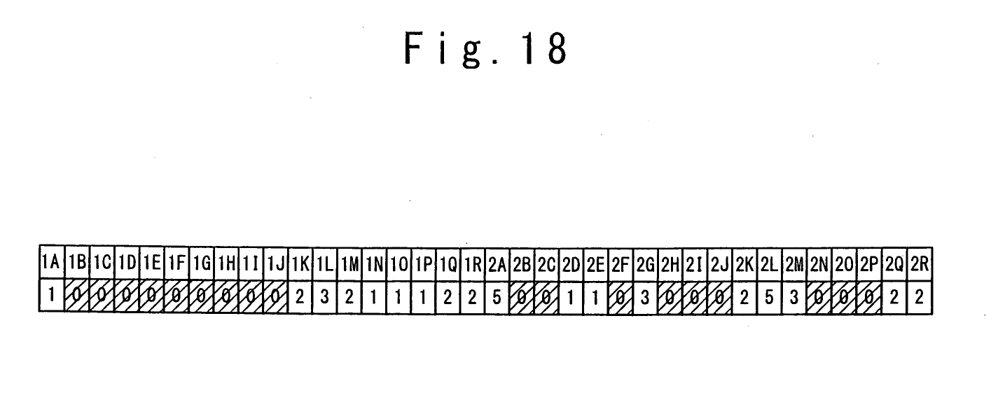

FIG. 18 shows the optimum common pattern. Here, portions of the coordinate totals for the respective coordinate names 1A to 2R on the tracks are extracted as the optimum common pattern from FIG. 16. The wiring data for the first layer is “100000000023211122” in the order of 1A to 1R. The wiring data for the second layer is “500110300025300022” in the order of 2A to 2R. Portions of the coordinate total of “0” are indicated by hatching.

### (9) Step S209

The design tool 11 generates a cell in which dummy metals are arranged based on the optimum common pattern obtained at Step S208.

Although not shown, the design tool 11 includes function units for executing the processes of Steps S201 to S209. Here, the design tool 11 includes, as components of the dummy metal-arranged layout cell generation process unit (Step S105), a cell information summarization process unit (Step S201), a layout cell selection process unit (Step S202), a wiring data conversion process unit (Step S203), a wiring data summarization process unit (Step S204), a non-common pattern retrieval process unit (Step S205), a non-common pattern elimination process unit (Step S206), an arranged dummy metal number calculation process unit (Step S207), an arranged dummy metal number judgment process unit (Step S208) and a new layout cell generation process unit (Step S209). It should be noted that although these units are conceptually separated from each other, these units may be integrated physically in arbitrary combination.

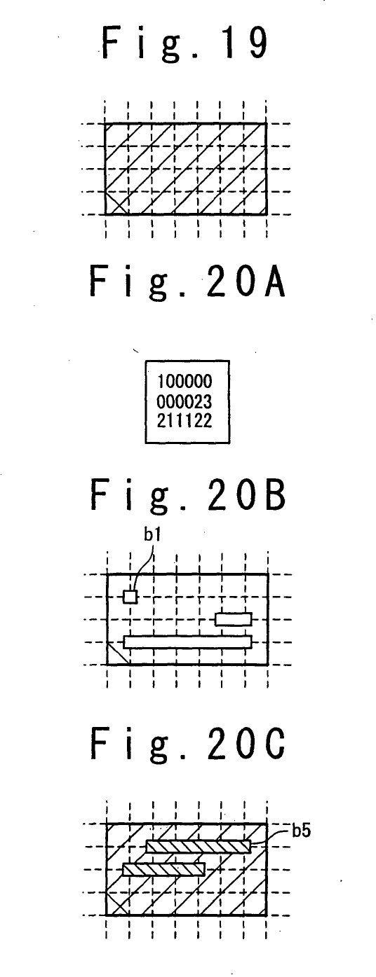

FIG. 19 shows a new layout cell (cell name: CELL1). The optimum common pattern is data based on which a dummy metal is arranged in the new layout cell at a track coordinate having a value of zero and any dummy metal is not arranged at a track coordinate having a value of one or more.

For example, FIG. 20A shows the first layer wiring data of the optimum common pattern in FIG. 18 on the coordinates. Accordingly, the first layer wiring data is “100000000023211122” in the order of 1A to 1R. The value of zero represents that there is no wiring in all of the instances a1, a2, and a4 to a9. The value of one or more represents that there is a wiring in one or more of the instances a1, a2, and a4 to a9.

FIG. 20B shows a working layout cell in which first layer wirings b1 are arranged at the coordinates A to R based on the wiring data “100000000023211122” in FIG. 20A.

Dummy metals are arranged at locations in FIG. 20B, at which there is no first layer wiring. Namely, a dummy metal is arranged in a case of zero, and any dummy metal is not arranged in a case of one or more.

FIG. 20C shows a working layout cell in which first layer dummy metals b5 are arranged at the coordinates A to R based on the wiring data “100000000023211122” in FIG. 20A.

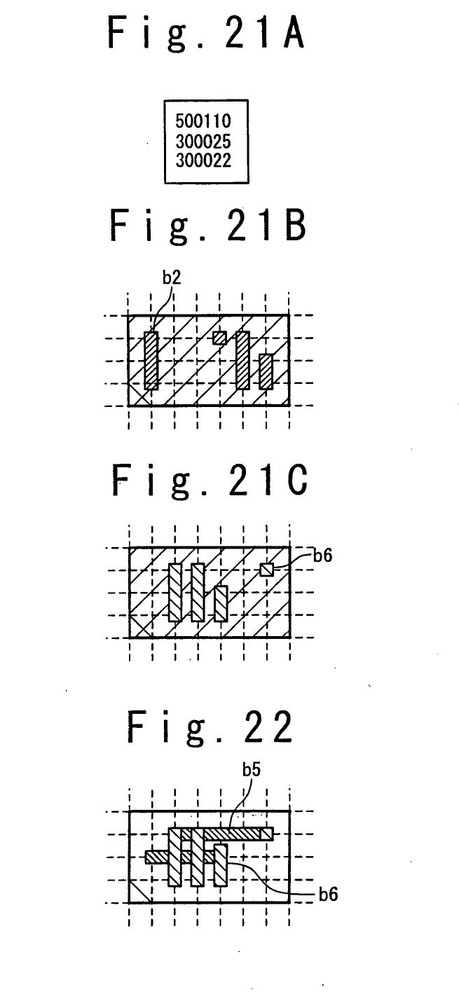

Similarly, FIG. 21A shows the second layer wiring data of the optimum common pattern in FIG. 18 on the coordinates. The second layer wiring data is “500110300025300022” in the order of 2A to 2R.

FIG. 21B shows a working layout cell in which second layer wirings b10 are arranged at the coordinates A to R based on the wiring data “500110300025300022” in FIG. 21A.

FIG. 21C shows a working layout cell in which second layer dummy metals b6 are arranged at the coordinates A to R based on the wiring data “500110300025300022” in FIG. 21A.

According to the above-mentioned procedure, locations at which dummy metals of the respective layer are arranged are specified, a cell is newly generated in which dummy metals are arranged in advance at the locations, and the cell is added to the cell library. The newly generated cell is referred to as “new layout cell”.

FIG. 22 shows the new layout cell in which the first layer dummy metals 5 and the second layer dummy metals 6 are arranged based on the first layer wiring data “100000000023211122” and the second layer wiring data “500110300025300022” of the optimum common pattern in FIG. 18. The above-mentioned new layout cell is same in libraries except for the layout data as the cell from which the new layout data is generated.

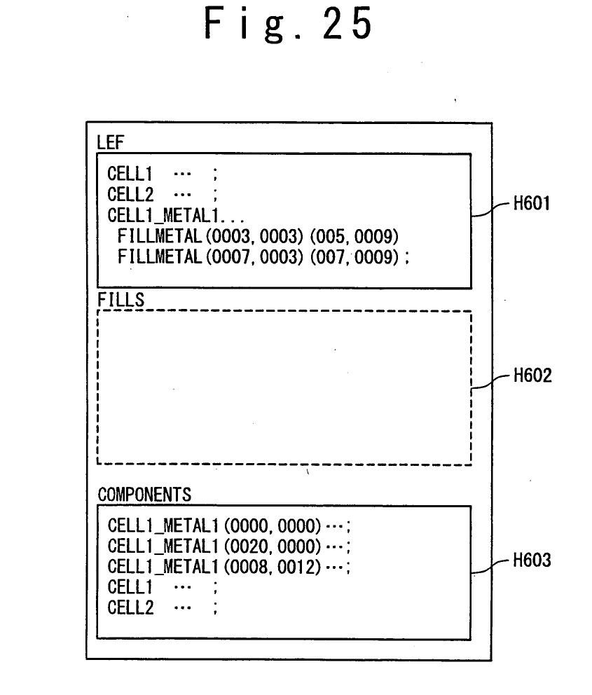

The design tool 11 executes the new layout cell replacement process at Step S106 by replacing a cell name in a layout cell arrangement coordinate description H603 in FIG. 25, which is described later.

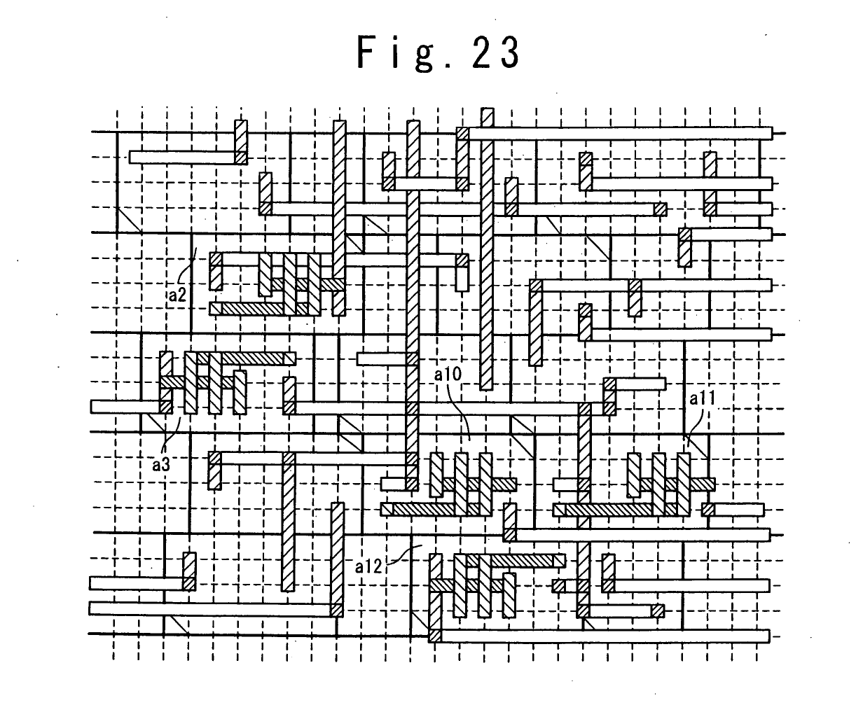

Cell replacement in layout will be described referring to FIGS. 23 and 25.

As shown in FIG. 23, with respect to each of the five instances a2, a3, and a10 to a12 in the layout shown in FIG. 8, CELL1 having no dummy metal is replaced by CELL1_METAL1 as the new layout cell having dummy metal.

Replacement between the original layout cell and the new layout cell is achieved by executing the replacement of cell name in the layout cell arrangement coordinate description H603, namely by replacing CELL1 in the layout cell arrangement coordinate description H903 by CELL1_METAL1 in the layout cell arrangement coordinate description H603.

FIG. 25 shows an example of description of the layout data outputted as a result of the process. For example, the output can be displayed on a printed material or a screen.

FIG. 25 shows an example of description of layout data which is generated by processing the circuit in FIG. 5 according to the first embodiment of the present invention. A layout cell definition H601 defines layout cells and indicates an end of definition of one layout cell by a semicolon.

A dummy metal description H602 describes arrangement coordinates of dummy metals and indicates an end of description of an arrangement coordinate of one layout cell by a semicolon.

The layout cell arrangement coordinate description H603 describes the arrangement coordinates of the layout cells and indicates an end of description of an arrangement coordinate of one layout cell by a semicolon.

The definition of new layout cell is described as CELL1_METAL1 in the layout cell definition H601. When all dummy metals are arranged by using the new layout cells in the process according to the present embodiment, the dummy metal description H602 does not describe any dummy metal.

According to the present embodiment, a common location (coordinate) at which dummy metal is arranged is specified from the frequently-used layout cell, the new layout cell in which the dummy metal is arranged in advance at the specified arrangement location is generated, and the dummy metal is arranged by replacing the frequently-used layout cell from which the new layout cell is generated by the new layout cell having dummy metal.

According to the present embodiment, since the description of the arrangement coordinates of the dummy metals in the layout data can be described as the arrangement coordinates of cells by defining the new layout cells, data size required to describe the arrangement coordinates of the dummy metals in the layout data can be reduced.

As described above, an advantage is provided that an expensive computer having high throughputs and a large amount of memory does not required to be used for a process such as wiring correction in which data size depends on processing speed.

A mechanism for solving the above-mentioned problem will be described. According to the conventional art, in order to fill dummy metal, in the dummy metal arrangement at Step S104, the dummy wiring layout data 7a is arranged by describing arrangement coordinate in a layer for each dummy wiring layout data 7a. Therefore, description amount of the layout data increases depending on the data size of the filled dummy metal.

However, according to the present embodiment, in Steps S105 to 107, the description of the arrangement coordinates of the dummy metals in the layout data can be described as the arrangement coordinates of cells by defining the new layout cells. Therefore, data size required to describe the arrangement coordinates of the dummy metals in the layout data can be reduced.

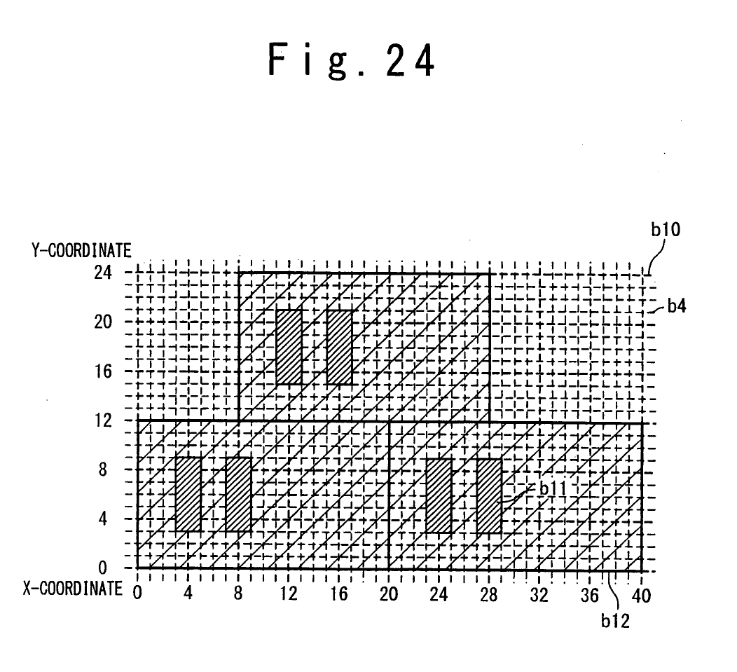

A specific data size will be described referring to FIGS. 24 and 25.

FIG. 24 shows layout in which three instances having the same function are arranged and each of the three instances has two dummy metals which are obtained according to the present embodiment and arranged in a layout cell. That is, the three instances have the six dummy metals in total.

FIG. 25 describes the layout in FIG. 24. In FIG. 24, a symbol b4 denotes a wiring track, a symbol b10 denotes a coordinate, a symbol b11 denotes a dummy metal, and a symbol b12 denotes an instance. The wiring tracks b4 can be wired with a pitch of four coordinates b10.

The layout cell definition H601 defines the layout cells. The new layout cell generated according to the present embodiment is added to the layout cell definition H601.

In the first embodiment of the present invention, CELL1_METAL1 as a cell of the cell type is defined and rectangular information of the dummy metal is described in the definition.

The dummy metal description H602 describes the arrangement coordinates of the dummy metals. When all dummy metals are arranged by using the new layout cells in the process according to the present embodiment, the dummy metal description H602 does not describe any dummy metal.

The layout cell arrangement coordinate description H603 describes the arrangement coordinates of the layout cells and describes the cell names and coordinates of the arranged layout cells.

According to the present embodiment, CELL1_METAL1 is generated and used as the new layout cell having two dummy metals.

The definition of the new layout cell having description of rectangles of two dummy metals is added to the layout cell definition H601. In the layout cell arrangement coordinate description H603, the dummy metals are arranged by replacing the layout cell from which the new layout cell is generated by the added new layout cell and by using the new layout cell.

As described above, since the dummy metals can be arranged by generating the new layout cell which describes rectangular information of the dummy metals and by replacing the layout cell name as in the case of the layout cell arrangement coordinate description H603, all of the six dummy metals are arranged. Therefore, the dummy metal description H602 includes no arranged data.

On the contrary, in the layout carried out according to the conventional procedure, the dummy metals are arranged by describing arrangement information for every dummy wiring layout data. Therefore, for example, rectangles of all of the six dummy metals are required to be described to express the dummy metals in the layout in FIG. 24.

As described above, by describing and using the dummy metals in the layout cell, the description of the arrangement coordinates of the dummy metals can be described as the arrangement coordinates of cells by defining the new layout cells. Therefore, data size required to describe the arrangement coordinates of the dummy metals in the layout data can be reduced.

Also when the above-mentioned layout data is used in the tool, the rectangular data can be expanded by describing the description of the arrangement coordinates of the dummy metals as the arrangement coordinates of cells by defining the new layout cells. Therefore, the rectangular data can be shared also in the tool. Consequently, data size required to describe the arrangement coordinates of the dummy metals can be reduced.

### Second Embodiment

A second embodiment of the present invention will be described below.

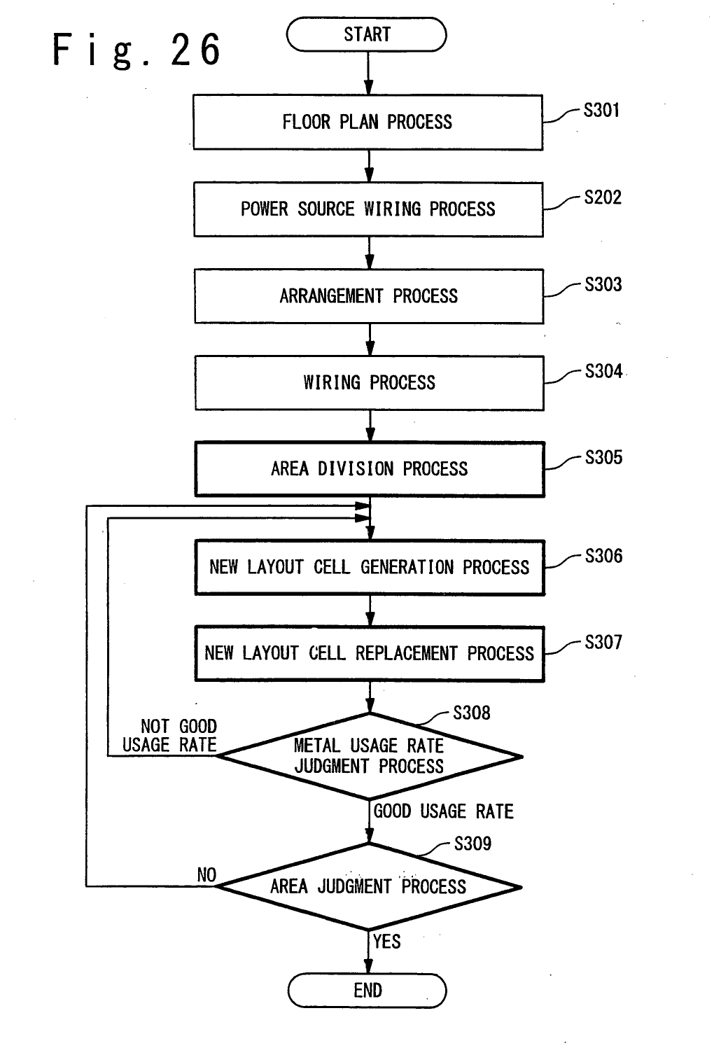

FIG. 26 is a flow chart of generating a new layout cell having dummy metals according to the second embodiment of the present invention.

Differences between the flow of FIG. 26 according to the second embodiment and the flow of FIG. 6 according to the first embodiment are addition of Steps S305 and S309.

In the flow of generating the new layout cell, the area of the layout as a target of process can be the whole chip as illustrated in the flow of FIG. 6. According to the second embodiment of the present invention, the process is executed for every divided area as illustrated in the flow of FIG. 26.

An outline of the second embodiment of the present invention will be described using the flow of FIG. 26.

### (1) Step S301

First, the design tool 11 performs floor plan arrangement of IO terminals and macros.

### (2) Step S302

Next, the design tool 11 performs a power source wiring.

### (3) Step S303

Next, the design tool 11 arranges respective layout cells.

### (4) Step S304

Next, the design tool 11 performs a signal wiring.

Steps S301 to S304 in the second embodiment of the present invention are the same as Steps S101 to S104 in the first embodiment.

### (5) Step S305

Next, the design tool 11 divides the layout as target into areas and processes each divided area.

Step S305 is an area division process. In the process, an arbitrary area such as an area in which metal usage rate is low is cut off from the layout data to be delivered to Step S306. By performing the area division process, the number of instances in the circuit, from which a common pattern is sought, is reduced. Therefore, a common pattern specific to the area can be obtained.

### (6) Step S306

Next, the design tool 11 specifies locations at which dummy metals are arranged, newly generates a layout cell in which dummy metals are arranged in advance at the specified locations, and adds the layout cell to the cell library.

### (7) Step S307

Next, the design tool 11 replaces the layout cell of the instance having the locations at which the dummy metals are arranged by the generated new layout cell having dummy metals.

### (8) Step S308

Next, the design tool 11 judges whether or not metal usage rate after replacement using the new layout cell satisfies a metal standard of the whole of one chip. When the metal usage rate after replacement does not satisfy the metal standard of the whole of one chip, the design tool 11 is shifted to the new layout cell generation process (Step S306) again. When the metal usage rate after replacement satisfies the metal standard of the whole of one chip, the design tool 11 is shifted to an area judgment process (Step S309).

Steps S306 to S308 in the second embodiment of the present invention are the same as Steps S105 to S107 in the first embodiment.

### (9) Step S309

Next, the design tool 11 checks whether all pieces of the layout data divided in Step S305 are processed. When there is unprocessed piece of the layout data, the design tool 11 is shifted to the new layout cell generation process (Step S306) again. When the all pieces of the layout data are processed, the design tool 11 terminates the flow.

Although not shown, the design tool 11 includes function units for executing the processes of Steps S301 to S309. Here, the design tool 11 includes a floor plan process unit (Step S301), a power source wiring process unit (Step S302), an arrangement process unit (Step S303), a wiring process unit (Step S304), an area division process unit (Step S305), a dummy metal-arranged layout cell generation process unit (Step S306), a dummy metal-arranged layout cell replacement process unit (Step S307), a metal usage rate judgment process unit (Step S308) and an area judgment process unit (Step S309). It should be noted that although these units are conceptually separated from each other, these units may be integrated physically in arbitrary combination.

In the second embodiment of the present invention, the number of instances as targets is reduced by dividing the layout into areas. Therefore, a common pattern specific to the area can be obtained and the new layout cell in which a larger number of dummy metals are arranged can be generated. As described above, the metal usage rate can be increased.

### Third Embodiment

A third embodiment of the present invention will be described.

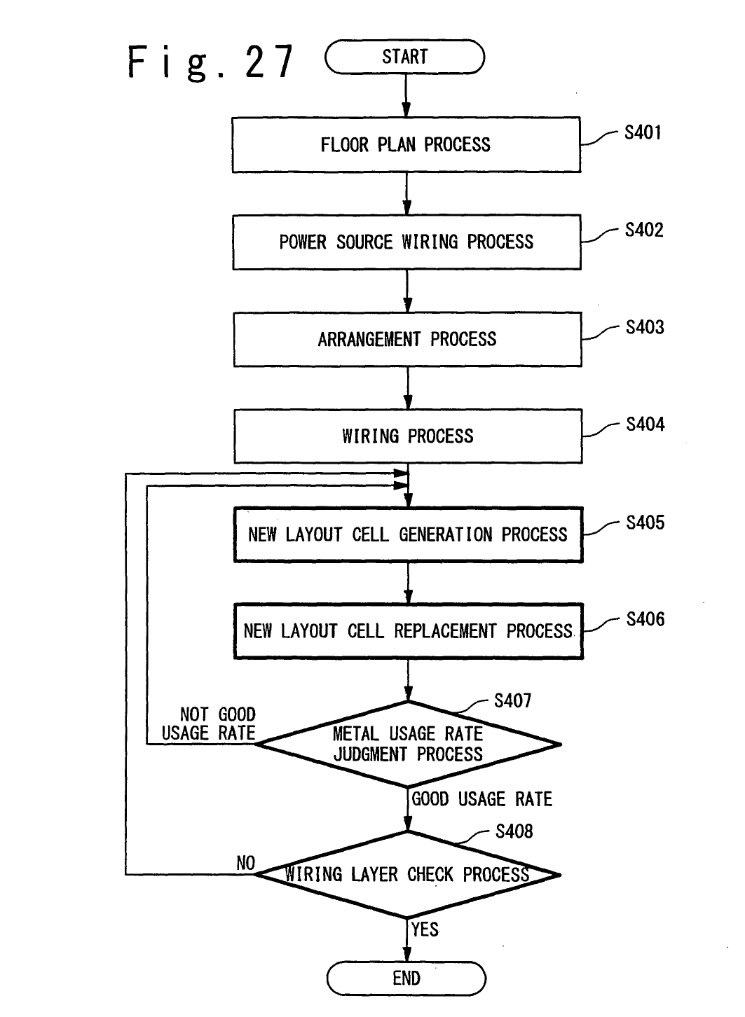

FIG. 27 is a flow chart of generating a new layout cell having dummy metals according to the third embodiment of the present invention.

With respect to differences between the flow of FIG. 27 according to the third embodiment and the flow of FIG. 6 according to the first embodiment, Step S408 is added and processes at Steps 405 and 406 according to the third embodiment are different from processes at Steps S105 and S106 according to the first embodiment.

The arrangement of dummy metal is executed for all the wiring layers at the same time in the flow of FIG. 6 according to the first embodiment, while the arrangement of dummy metal is executed for individual wiring layer in the flow of FIG. 27 according to the third embodiment.

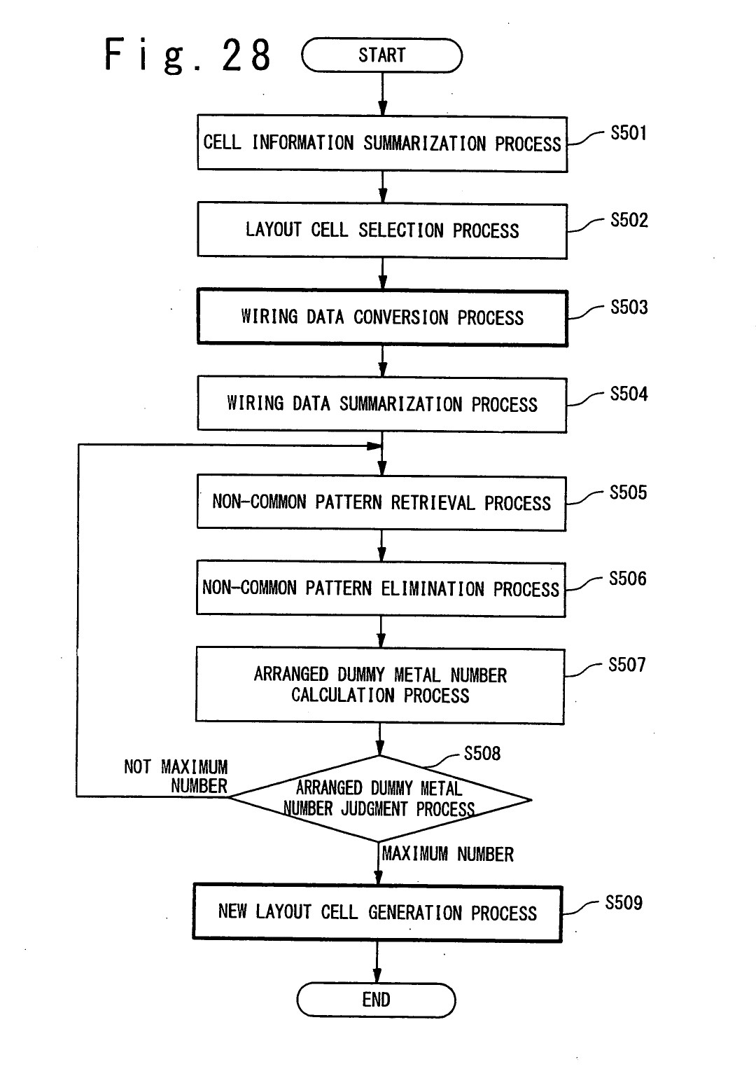

With respect to differences between the flow of FIG. 28 according to the third embodiment and the flow of FIG. 12 according to the first embodiment, processes at Steps 503 and 509 according to the third embodiment are different from processes at Steps S203 and S209 according to the first embodiment.

Therefore, in specifying common locations (coordinates) at which dummy metals are arranged, for example, even when there exist an instance in which dummy metals can be arranged in the first layer but cannot be arranged in the second layer, or even when there exist an instance in which dummy metals cannot be arranged in the first layer but can be arranged in the second layer, dummy metals can be arranged in each wiring layer.

An outline of the third embodiment of the present invention will be described referring to the flow of FIG. 27.

### (1) Step S401

First, the design tool 11 performs floor plan arrangement of IO terminals and macros.

### (2) Step S402

Next, the design tool 11 performs a power source wiring.

### (3) Step S403

Next, the design tool 11 arranges respective layout cells.

### (4) Step S404

Next, the design tool 11 performs a signal wiring.

Steps S401 to S404 in the third embodiment are the same as Steps S101 to S104 in first embodiment.

### (5) Step S405

Next, the design tool 11 specifies, with respect to an m-th layer (m is an integer of one to a integer corresponding to a topmost wiring layer), locations at which dummy metals are arranged, newly generates a layout cell in which dummy metals are arranged in advance at the specified locations, and adds the layout cell to the cell library.

### (6) Step S406

Next, the design tool 11 replaces the layout cell of the instance having the locations at which dummy metals are arranged with the generated new layout cell having dummy metals.

### (7) Step S407

The design tool 11 checks the metal usage rate. When the metal usage rate does not reach a target, the design tool 11 is shifted to a new layout cell generation process (Step S405) again with respect to only the area in which dummy metal is not arranged. When the metal usage rate reaches the target, the design tool 11 is shifted to a wiring layer check process (Step S408).

### (8) Step S408

The design tool 11 executes the wiring layer check process. When the m-th layer is not the topmost wiring layer, the design tool 11 increments m by one and is shifted to the new layout cell generation process (Step S405) again. When the m-th layer is the topmost wiring layer, the design tool 11 terminates this flow.

Although not shown, the design tool 11 includes function units for executing the processes of Steps S401 to S408. Here, the design tool 11 includes a floor plan process unit (Step S401), a power source wiring process unit (Step S402), an arrangement process unit (Step S403), a wiring process unit (Step S404), a dummy metal-arranged layout cell generation process unit (Step S405), a dummy metal-arranged layout cell replacement process unit (Step S406), a metal usage rate judgment process unit (Step S407) and a wiring layer check process unit (Step S408). It should be noted that although these units are conceptually separated from each other, these units may be integrated physically in arbitrary combination.

FIG. 28 is a flow chart showing the new layout cell generation process of Step S405 in detail.

### (1) Step S501

The design tool 11 classifies all instances in the layout data according to cell type, and for each cell type, calculates the number of cells and layout area of a cell to obtain the layout total area as the product of the number of cells and the layout area of the cell. In this manner, at Step S501, like Step S201 in the first embodiment, the cell information summarization process is executed.

### (2) Step S502

The design tool 11 selects CELL1 as the cell type having the largest total area of layout cell, which is obtained at Step s501. In this manner, at Step S502, like Step S202 in the first embodiment, the layout cell selection process is executed.

### (3) Step S503

The design tool 11 generates a wiring database for the instances using CELL1 selected at Step S502. At Step S503, the generation of wiring database for all the wiring layers as described as Step S203 in the first embodiment is not executed, and the generation of wiring database for only m-th layer (m is an integer of one to the integer corresponding the topmost wiring layer) is executed.

### (4) Step 504

The design tool 11 summarizes values in the wiring database that are generated at Step S503. In this manner, at Step 504, like Step S204 in the first embodiment, the wiring data conversion process is executed.

### (5) Step S505

The design tool 11 selects an instance having a minimum number of the coordinate totals obtained at Step S504. When there are a plurality of coordinates having the minimum number, an instance having a maximum number of the wiring layer total is selected among the selected plurality of instances. In other words, an instance that uses the corresponding wiring layer most in the layout cell having the maximum number of coordinates without wiring is selected.

### (6) Step S506

Like Step S206 in the first embodiment, the design tool 11 regenerates the wiring database in which the instance a7 selected at Step S505 is eliminated.

### (7) Step S507

Like Step S207 in the first embodiment, the design tool 11 calculates a number of intersections (coordinates) of the wiring tracks in the wiring database generated at Step S506. The number of intersections (coordinates) of the wiring tracks is a value obtained by calculating a number of coordinates having the coordinate total of “0” and multiplying the number of coordinates by the number of remaining instances other than the instance eliminated at Step S506.

### (8) Step S508

The design tool 11 repeats the processes of Steps S505 to S507 for n times (n is two or more integer) using the wiring database generated again at Step S506 to judge an optimum common pattern, as described in the first embodiment.

### (9) Step S509

The design tool 11 generates a cell in which dummy metals are arranged based on the optimum common pattern obtained at Step S508. Although the dummy metals are arranged in the selected layout cell in the first embodiment, in the new layout cell generation process of Step S509, the new layout cell generated in the third embodiment is METAL1 as a cell of cell type having only information of dummy metals in the m-th wiring layer.

Although not shown, the design tool 11 includes function units for executing the processes of Steps S501 to S509. Here, the design tool 11 includes, as components of the dummy metal-arranged layout cell generation process unit (Step S405), a cell information summarization process unit (Step S501), a layout cell selection process unit (Step S502), a wiring data conversion process unit (Step S503), a wiring data summarization process unit (Step S504), a non-common pattern retrieval process unit (Step S505), a non-common pattern elimination process unit (Step S506), an arranged dummy metal number calculation process unit (Step S507), an arranged dummy metal number judgment process unit (Step S508) and a new layout cell generation process unit (Step S509). It should be noted that although these units are conceptually separated from each other, these units may be integrated physically in arbitrary combination.

In the third embodiment of the present invention, in the new layout cell replacement process at Step S406, the design tool 11 arranges dummy metals by arranging METAL1 as the cell of the cell type so as to overlap the coordinate of the layout cell of the instance selected at Step S505, from which METAL1 is generated.

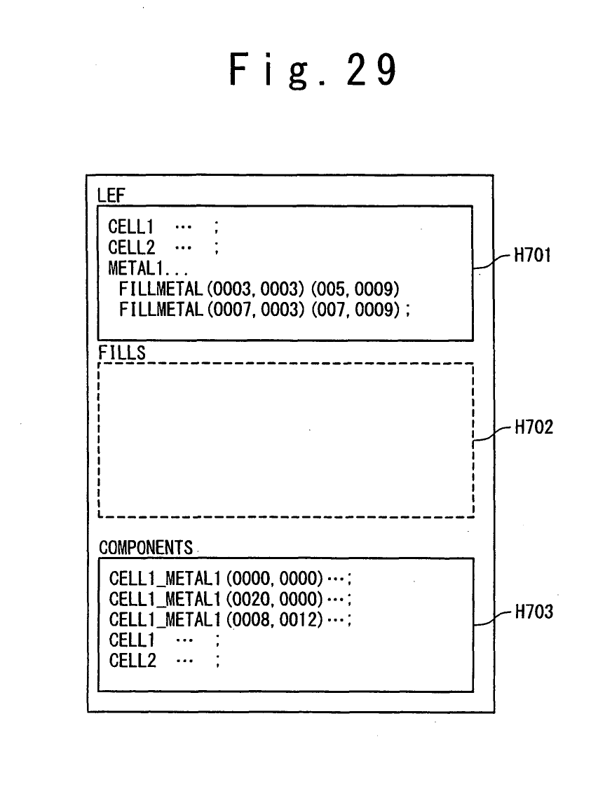

FIG. 29 shows an example of description of layout data which is generated by processing the circuit in FIG. 5 according to the third embodiment of the present invention.

A layout cell definition H701 defines layout cells and indicates an end of definition of one layout cell by a semicolon,

A dummy metal description H702 describes arrangement coordinates of dummy metals and indicates an end of description of an arrangement coordinate of one layout cell by a semicolon.

A layout cell arrangement coordinate description H703 describes the arrangement coordinates of the layout cells and indicates an end of description of an arrangement coordinate of one layout cell by a semicolon.

In the layout cell arrangement coordinate description H703, METAL1 having only the dummy metal information is arranged along with the description of the coordinate of the layout cell of the instance selected at Step S205, from which METAL1 is generated. In the present embodiment, by describing METAL1 as the new layout cell having only dummy metals and CELL 1 side by side in the layout cell arrangement coordinate description H703 in FIG. 29, METAL1 is arranged at the same coordinate as that of CELL1 which is arranged at the coordinate (0000, 0000) such that METAL1 and CELL1 are overlapped.

In the third embodiment, by executing the dummy metal arrangement for each wiring layer, even when the common locations (coordinates) at which dummy metals are arranged are specified, the new layout cell in which many dummy metals are arranged can be generated.

For example, even when there exist an instance in which dummy metals can be arranged in the first layer but cannot be arranged in the second layer, or even when there exist an instance in which dummy metals cannot be arranged in the first layer but can be arranged in the second layer, the dummy metal arrangement can be executed for each wiring layer. Therefore, the new layout cell in which many dummy metals are arranged can be generated. Furthermore, as described above, the metal usage rate can be increased.

According to the embodiment, as a first procedure, a common location (coordinate) at which dummy metal is arranged is specified from a frequently-used layout cell, a new layout cell in which dummy metal is arranged is generated, and dummy metal is arranged by replacing the layout cell from which the new layout cell is generated by the new layout cell having dummy metal.

According to the procedure, the description of the arrangement coordinates of the dummy metals in the layout data can be described as the arrangement coordinates of cells by defining the new layout cells and data size required to describe the arrangement coordinates of the dummy metals in the layout data can be reduced. Therefore, a process such as wiring correction in which data size depends on processing speed can be carried out by using an inexpensive computer having low throughputs and the small amount of memory.

Furthermore, by using a machine having throughputs and amount of memory required for the conventional method, the process can be carried out in a shorter process time.

According to the embodiment, as a second procedure, the layout area is divided to arrange dummy metals.

According to the procedure, since the number of instances as targets is reduced, the new layout cell in which a larger number of dummy metals are arranged can be generated. As described above, the metal usage rate can be increased.

According to the embodiment, as a third procedure, the dummy metal arrangement is executed for each wiring layer.

According to the procedure, since the optimum common pattern is retrieved for each wiring layer, the new layout cell in which a larger number of dummy metals are arranged can be generated. Thus, the metal usage rate can be increased.

According to a layout design method according to the embodiment as a layout design method of semiconductor integrated circuit includes: a step of generating a new layout cell; and a step of arranging dummy metal. In the step of generating the new layout cell, a common location (coordinate) at which dummy metal is arranged is specified by selecting a frequently-used layout cell, and the new layout cell in which the dummy metal is arranged in advance at the specified arrangement location is generated. In the step of arranging the dummy metal, the dummy metal is arranged by replacing the frequently-used layout cell from which the new layout cell is generated by the new layout cell having dummy metal or by overlapping them.

The step of generating the new layout cell includes a layout cell information summarization process, a layout cell selection process, a wiring data conversion process, a wiring data summarization process, a non-common pattern retrieval process, a non-common pattern elimination process, an arranged dummy metal number calculation process, an arranged dummy metal number judgment process, and a new layout cell generation process.

The layout cell information summarization process includes a step of multiplying the use number of layout cell in a target circuit by the area of the layout cell.

The layout cell selection process includes a step of selecting layout cell having the largest value among values obtained in the layout cell information summarization process.

The wiring data conversion process includes a step of digitizing coordinates-on-tracks of an instance having the selected layout cell to 0 or 1, and a step of generating wiring database of the instance.

The wiring data summarization process includes a step of calculating a coordinate total for each coordinate on each track, a step of calculating a layer total of the instance for each wiring layer, and a step of calculating total number of metals.

The non-common pattern retrieval process includes a step of retrieving an instance to be eliminated based on the coordinate total and the layer total.

The non-common pattern elimination process includes a step of updating the generated database by eliminating the retrieved instance from the generated database.

The arranged dummy metal number calculation process includes a step of calculating the total number of dummy metals in the updated database.

The arranged dummy metal judgment process includes a step of judging whether or not the calculated total number of dummy metals is a maximum value to determine an optimum common pattern.

The new layout cell generation process includes a step of generating the new layout cell having dummy metal based on the determined optimum common pattern.

The step of generating new layout cell includes a step of dividing layout data into arbitrary areas, and a step of judging whether or not the new layout cell generation process and a new layout cell replacement process are executed for the divided areas.

The step of generating new layout cell includes a step of executing the new layout cell generation process for each wiring layer, and a step of judging whether or not the new layout cell generation process is executed for all wiring layers.

The above-mentioned embodiments can be implemented in combination.

The embodiments of the present invention have been specifically described. However, the present invention is not limited to the above embodiments, but may be modified and changed without departing from the scope and spirit of the invention.

What is claimed is:

1. A layout design system comprising:
a first unit which selects a layout cell based on layout design and usage rate in a semiconductor integrated circuit, specifies a common coordinate at which dummy metal is arranged for the selected layout cell, and generates a new layout cell in which dummy metal is arranged in advance at the specified coordinate; and
a second unit which uses the new layout cell in place of the selected layout cell.

2. The layout design system according to claim 1, wherein the first unit includes a layout cell information summarization process unit which multiplies use number of a layout cell in a target circuit by area of the layout cell.

3. The layout design system according to claim 2, wherein the first unit includes a layout cell selection process unit which select a layout cell for which a value obtained by multiplying the use number by the area is maximum.

4. The layout design system according to claim 3, wherein the first unit includes a wiring data conversion process unit which digitizes coordinates-on-track of instances having the selected layout cell into zero or one to generate wiring database of the instances.

5. The layout design system according to claim 4, wherein the first unit includes:
a coordinate data summarization process unit which calculate a coordinate total for each of the coordinates-on-track;
a layer data summarization process unit which calculate a layer total of the instance for each of wiring layers; and
a metal number data summarization process unit which calculates total number of metals of the instances.

6. The layout design system according to claim 5, wherein the first unit includes a non-common pattern retrieval process unit which retrieves an instance to be eliminated based on the coordinate total and the layer total.

7. The layout design system according to claim 6, wherein the first unit includes a non-common pattern elimination process unit which updates the generated database by eliminating the retrieved instance from the generated database.

8. The layout design system according to claim 7, wherein the first unit includes an arranged dummy metal number calculation process unit which calculates a total number of dummy metals based on the updated database.

9. The layout design system according to claim 8, wherein the first unit includes an arranged dummy metal number judgment process unit which judges whether or not the calculated total number of dummy metals to determine an optimum common pattern.

10. The layout design system according to claim 9, wherein the first unit includes:
a new layout cell generation process unit which generates a new layout cell having dummy metal based on the determined optimum common pattern; and
a new layout replacement unit which replaces a layout cell from which the new layout cell is generated by the new layout cell.

11. The layout design system according to claim 10, wherein the first unit includes:
an area division process unit which divides layout data into arbitrary areas; and
an area judgment process unit which judges whether or not the new layout cell generation process unit and the new layout replacement process unit are executed for the divided areas.

12. The layout design system according to claim 1, wherein the first unit includes a wiring layer check process unit which when a new layout cell generation process is executed for each of wiring layers, judges whether or not the new layout cell generation process is executed for all of the wiring layers.

13. A layout design method of a semiconductor integrated circuit comprising:
generating a new layout cell in which dummy metal is arranged in advance at a specified coordinate; and
using the new layout cell in place of a selected layout cell,
wherein the generating the new layout cell includes:
selecting a layout cell as the selected layout cell based on layout design and usage rate; and
specifies a common coordinate as the specified coordinate at which dummy metal is arranged for the selected layout cell.

14. The layout design method according to claim 13, wherein the generating the new layout cell includes multiplying use number of a layout cell in a target circuit by area of the layout cell.

15. The layout design method according to claim 14, wherein the generating the new layout cell includes selecting a layout cell for which a value obtained by multiplying the use number by the area is maximum.

16. The layout design method according to claim 15, wherein the generating the new layout cell includes:
digitizing coordinates-on-track of instances having the selected layout cell into zero or one; and
generating wiring database of the instances.

17. The layout design method according to claim 16, wherein the generating the new layout cell includes:
calculating a coordinate total for each of the coordinates-on-track;
calculating a layer total of the instance for each of wiring layers; and
calculating total number of metals of the instances.

18. The layout design method according to claim 17, wherein the generating the new layout cell includes retrieving an instance to be eliminated based on the coordinate total and the layer total.

19. The layout design method according to claim 18, wherein the generating the new layout cell includes updating the generated database by eliminating the retrieved instance from the generated database.

20. The layout design method according to claim 13, wherein the generating the new layout cell includes:
executing a new layout cell generation process for each of wiring layers; and
judging whether or not the new layout cell generation process is executed for all of the wiring layers.
